(19) United States
(12) Patent Application Publication
(10) Pub. No.: US 2015/0304387 A1
(43) Pub. Date: Oct. 22, 2015

(54) PERFORMING SYNCHRONIZED E-BOOK ACTIVITIES BETWEEN A PLURALITY OF DEVICES

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/259,034

(22) Filed: Apr. 22, 2014

(51) Int. Cl. H04L 29/08; G06F 3/0484; H04L 12/24

(52) U.S. Cl. CPC H04L 67/025; H04L 41/22; G06F 3/0484

(57) ABSTRACT

A computing device can establish a wireless connection with at least one other computing device using a shared network. The computing device can display a portion of content of an e-book and receive user input for interacting with the displayed portion of content. In response to receiving the user input, the computing device performs an e-book activity with respect to the displayed portion based on the user input, and concurrently transmits, to the at least one other computing device using the wireless connection, a control signal that causes the at least one other computing device to perform an identical corresponding e-book activity on a corresponding portion of content displayed on the at least one other computing device.

### TECHNICAL FIELD

Embodiments described herein relate to an e-reader device, and more specifically, to an e-reader device to perform synchronized e-book activities with another e-reader device.

### BACKGROUND

An electronic personal display is a mobile electronic device that displays information to a user. While an electronic personal display may be capable of many of the functions of a personal computer, a user can typically interact directly with an electronic personal display without the use of a keyboard. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (e-books), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to perform synchronized e-book activities with another computing device, according to an embodiment.

FIG. 2 illustrates an example of an e-reader device or other electronic personal display device, for use with one or more embodiments described herein.

FIG. 3 illustrates an e-book device system for performing synchronized e-book activities with another computing device, according to an embodiment.

FIG. 4 illustrates a computer-implemented method for performing synchronized e-book activities with another computing device, according to at least some embodiments.

### DETAILED DESCRIPTION

Examples described herein include a computing device that establishes a wireless connection with another computing device, and further performs synchronized e-book activities with the other computing device using the wireless connection.

In examples described herein, a content item from which text items can be translated can have a predefined structure and format. By way of example, a content item can correspond to an e-book (including electronic magazines or comic books) having pagination and/or chapter designations, and a format such as Electronic Publication (“EPUB”), APABI, Hypertext Markup Language (“HTML”), iBOOK, KF8, MICROSOFT LIT, AZW, or Digital Accessible Information System (“DAISY”). In variations, the content item can correspond to a document having pagination and/or chapter designations in formats such as Portable Document Format (“PDF”) or Plain text files.

In an embodiment, a computing device establishes a wireless connection with at least one other computing device using a sharing network. The computing device can establish the sharing network in order to enable synchronization of e-book activities between the computing device and the at least one other computing device for a specified duration of time. When a user operates the computing device by providing input to interact with a displayed portion of content of an e-book, the computing device can perform an e-book activity based on the input and concurrently transmit a control signal to the at least one other computing device to cause the at least one other computing device to perform an identical corresponding e-book activity on a corresponding portion of content displayed on the at least one other computing device. By enabling synchronization of e-book activities between devices, users can collaborate together and share the same e-book reading experiences on their respective devices. Sharing e-book experiences can be useful in certain settings, such as for academic purposes or in classroom settings, or for book club events or other group-focused of events.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

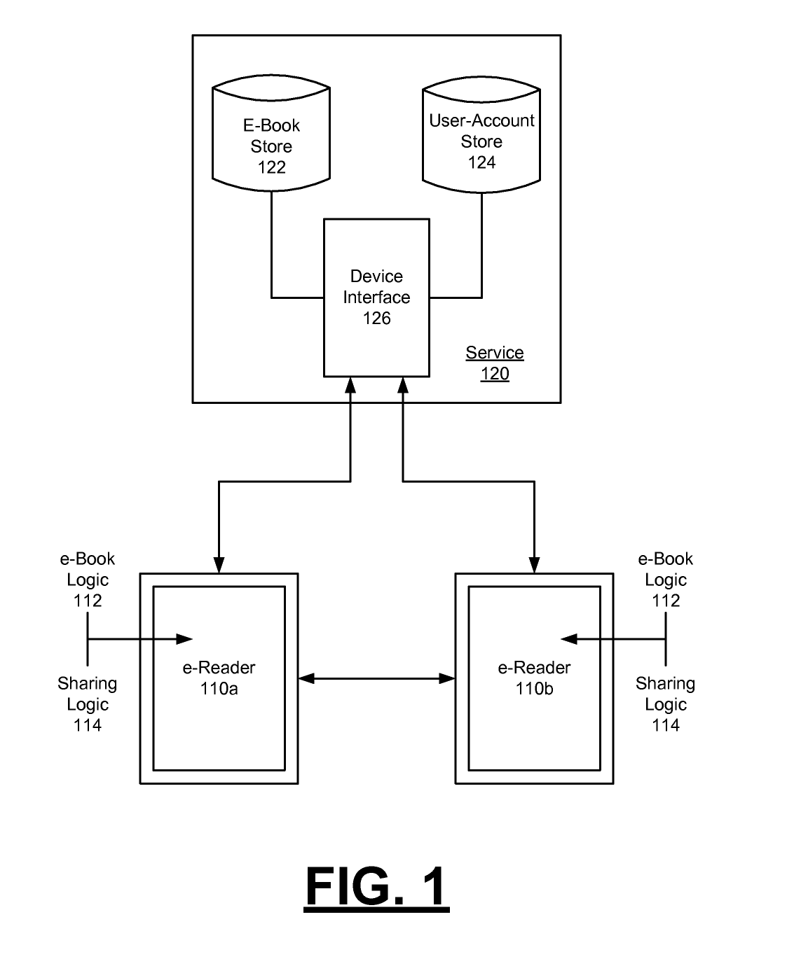

FIG. 1 illustrates a system for operating a computing device to perform synchronized e-book activities with another computing device, according to an embodiment. In an example of FIG. 1, the system includes a first electronic display device, shown by way of example as an e-reader device 110a, a similar second electronic display device, shown by way of example as an e-reader device 110b, and a network service 120. The e-reader devices 110a, 110b can communicate with the network service 120 over one or more networks (e.g., wirelessly) and can also communicate with each other using a sharing network. The network service 120 may include multiple servers and other computing resources that provide various services in connection with one or more applications that are installed on the e-reader devices 110a, 110b. By way of example, in one implementation, the network service 120 provides e-book services, which communicate with each of the e-reader devices 110a, 110b. The e-book services provided through network service 120 can, for example, include services in which e-books are sold, shared, downloaded and/or stored. More generally, the network service 120 can provide various other content services, including content rendering services (e.g., streaming media) or other network-application environments or services.

Each e-reader device 110a, 110b can correspond to any electronic personal display device on which applications and application resources (e.g., e-books, media files, documents) can be rendered and consumed. In one example, each of the e-reader devices 110a, 110b correspond to a tablet or a telephony/messaging device (e.g., smart phone). For example, each e-reader device 110a, 110b can have a tablet like form factor, although variations are possible. In some cases, the e-reader devices 110a, 110b can also have an E-ink display.

In one example, each e-reader device 110a, 110b also runs an e-reader application that links the respective device to the network service 120 and enables e-books provided through the service to be viewed and consumed by a user. An e-book can correspond to a publication or a document in digital form, comprising text and/or graphics, which can be displayed on individual e-reader devices 110a, 110b. In another implementation, the e-reader devices 110a, 110b can run a media playback or streaming application which receives files or streaming data from the network service 120. By way of example, the e-reader devices 110a, 110b can be equipped with hardware and software to optimize certain application activities, such as rendering of electronic content (e.g., e-books). Although examples described herein refer to e-books, the e-reader devices 110a, 110b can display other types of documents, such as a .pdf file, a .doc file, a .txt file, etc., and in general, can display other content items that include text content.

In additional detail, the network service 120 can include a resource store 122, a user account store 124, and a device interface 126. The resource store 122 can store a plurality of documents, such as e-books, to be accessed by the e-reader devices 110a, 110b (and other e-reader devices) that are registered or subscribed with the network service 120. The user account store 124 can store information that associates each e-reader device 110a, 110b with a user and with an account. The account can also be associated with one or more application resources or content items (e.g., e-books), which can be stored in the resource store 122. The device interface 126 enables individual e-reader devices 110a, 110b to communicate with the network service 120.

As described further, the user account store 124 can retain metadata for individual accounts to identify resources that have been purchased or made available for consumption for a given account. Each e-reader device 110a, 110b may be associated with a user account, and multiple devices may be associated with the same account. As described in greater detail below, each e-reader device 110a, 110b can store content items (e.g., e-books) that are purchased or otherwise made available to the user of that e-reader device 110a, 110b, as well as to archive e-books and other digital content items that have been purchased for the user account, but are not stored on the particular e-reader device 110a, 110b.

With further reference to FIG. 1, each e-reader device 110a, 110b can include e-book logic 112 and sharing logic 114. The e-book logic 112 operates to enable a user of an e-reader device 110a, 110b to access, view, and/or edit a collection of digital content items belonging to a user (e.g., digital content items that the user has purchased for download, licensed, or otherwise obtained a right of possession). The e-book logic 112 can also operate to communicate with the network service 120 to browse, view, and/or purchase, license, or obtain rights to other content items. In some examples, the e-book logic 112 also operates to display graphic representations of individual content items. For example, the e-book logic 112 can display icons representing album covers, movie titles, and television shows. In the context of e-books, the e-book logic 112 displays icons representing book covers or jackets, magazine covers, comic book covers etc., corresponding to content items belonging to the user. The e-book logic 112 can provide multiple organizational structures for displaying graphic representations of content items, such as in lists, folders, or virtual structures, such as bookshelves (for e-books). The e-book logic 112 enables the user to select a content item, such as an e-book, and displays a portion of content (e.g., text, graphics) of the selected content item (e.g., display a page of the e-book in a paginated view) on a display of individual e-reader devices 110a, 110b.

Each e-reader device 110a, 110b can include sharing logic 114, which operates to provide a sharing environment for e-reader devices so that synchronized e-book activities can be performed on the e-reader devices. The sharing logic 114 can provide a user interface to enable a host user operating a host device, such as e-reader device 110a, to set up or configure the sharing environment (e.g., a private ad-hoc sharing network) with other devices (operated by guest users). As referred to herein, a host device can correspond to a computing device that establishes a sharing network or environment for purposes of synchronizing e-book activities. In some examples, the sharing logic 114 also interacts with the e-book logic 112 to determine when the user provides an input corresponding to an e-book activity and to provide a control signal to the other device(s) in the sharing network to cause the other device(s) to perform an identical corresponding e-book activity.

For example, a host user can operate the e-reader device 110a to create a private sharing network for an e-book sharing session, configure the settings for the sharing network and the e-book sharing session, select an e-book for the sharing session, and invite or select other users or e-reader devices, such as the e-reader device 110b to join the e-book sharing session. The e-reader device 110a, 110b can include copies of the same e-book (e.g., stored locally on each e-reader device 110a, 110b) for purposes of collaboration, such as in a classroom or book club setting. When the e-reader device 110b joins the sharing network, a wireless connection can be established between the e-reader device 110a and the e-reader device 110b, and e-book activities can be synchronized between the devices in accordance with the settings for the e-book sharing session. In this manner, when the host performs an e-book activity on an e-book on the e-reader device 110a, an identical e-book activity can be automatically performed on the e-book on the e-reader device 110b, thereby synchronizing e-book activities to be performed in unison (or at least substantially concurrently). Similarly, based on the settings for the for the e-book sharing session, the user of the e-reader device 110b may perform an e-book activity on the e-book on the e-reader device 110b and automatically cause an identical e-book activity to be performed on the e-book of the e-reader device 110a.

As described herein, an e-book activity can include one or more of a page-turning operation from a displayed page to another page (e.g., the next page or previous page), a page-jumping operation (e.g., jump to different pages, sections, chapters, etc.), highlighting or selecting text or other content (e.g., image, video) on a displayed page, generating an annotation on a displayed page, sharing notes, displaying a definition of a selected text on a displayed page, zooming in or zooming out of a displayed page, or other operations pertaining to an e-book. Although FIG. 1 illustrates two e-reader devices 110a, 100b, other examples include additional other e-reader devices (not shown in FIG. 1) that can be a part of the sharing network for participating in the e-book sharing session.

Hardware Description

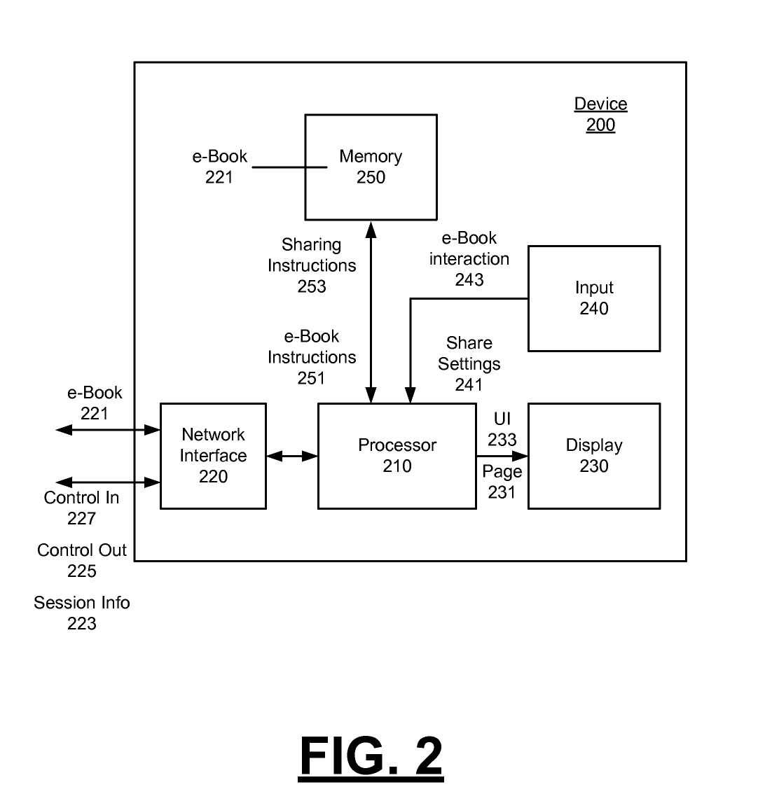

FIG. 2 illustrates an example of an e-reader device or other electronic personal display device, for use with one or more embodiments described herein. In an example of FIG. 2, an e-reader device 200 corresponds to, for example, an e-reader device 110a and/or an e-reader device 110b, such as also shown by an example of FIG. 1. With reference to FIG. 2, the e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 and with one or more other computing devices, such as other e-reader devices (see FIG. 1). More specifically, the e-reader device 200 can access the network service 120 to receive various kinds of resources (e.g., digital content items, such as e-books, configuration files, account information), as well as to provide information (e.g., user account information, service requests, etc.). For example, the e-reader device 200 can receive content items, such as e-books 221 or media files, that the user elects to purchase and/or otherwise download from the network service 120. The content items that are downloaded onto the e-reader device 200 can be stored in the memory 250.

In some implementations, the display 230 can correspond to, for example, a liquid crystal display (LCD) or light emitting diode (LED) display that illuminates in order to provide content generated from the processor 210. In some examples, the display 230 can be touch-sensitive. In some variations, the display 230 can correspond to an electronic paper type display, which mimics conventional paper in the manner in which they display content. Examples of such display technologies include electrophoretic displays, electrowetting displays, and electrofluidic displays.

The processor 210 can receive input from various sources, including from one or more input mechanisms 240 (e.g., buttons or switches, microphone, keyboard, etc.), the display 230 (e.g., soft buttons or keyboard presented on a touch-sensitive display), or other input mechanisms (e.g., accessory devices that are connected to the e-reader device 200 via a cable or via a wireless communication medium, such as Bluetooth). The processor 210 can receive user input and based on the user input, identify a content item (e.g., e-book 221) for display and display a portion of text content of the content item on the display 230. The user can provide user input to interact with the displayed e-book 221 (e.g., change pages, make bookmarks, add notes, highlight text, etc.) to cause the e-reader device 200 to perform e-book activities.

With further reference to FIG. 2, the memory 250 can store instructions 251 for implementing e-book logic 112 (see FIG. 1) and instructions 253 for implementing sharing logic 112 (see FIG. 1). As discussed, application resources, such as content items (e.g., e-books 221), can be received by the network interface 220 from, for example, the network service 120 and stored in the memory 250. Each e-book 221 can include a metadata set and content portion. The metadata set can include, for example, the graphic representation of the e-book 221, such as an iconic representation of a book cover, as well as summary information, author, title, short synapse, language of the e-book, etc.

In one implementation, the processor 210 executes the e-book instructions 251 for implementing the e-book logic 112 to display a selected e-book on the display 230. For example, the processor 210 implements the e-book logic 112 to display, within a display area of the display 230, a portion of content (e.g., a page 231) from the content item (e.g., the e-book 221). The e-book instructions 251 for implementing the e-book logic 112 can use input provided by a user via user interaction with the input mechanism 240 and/or display 230 (e.g., touchscreen input) to identify the e-book 221 from the memory 250 (e.g., the user selects a graphic corresponding to a cover of the e-book 221 from a bookshelf user interface view) and to display the e-book 221 (e.g., a page 231) on the display 230.

The processor 210 also implements the e-book logic 112 to provide different options and features for the user. The user can interact with one or more selectable features or icons to cause the e-reader device 200 to perform additional operations (e.g., operations other than just displaying content), such as note taking, highlighting, searching, looking up a definition, sharing information with other users, etc. For example, the processor 210 implements the e-book logic 112 by executing the e-book instructions 251 to display a portion of content of a content item (e.g., a document or an e-book 221) on the display 230. The processor 210 also executes the e-book instructions 251 to receive user input, such as a user input to perform e-book activities.

According to an example, the processor 210 can also execute other instructions (not shown in FIG. 2) for implementing a settings logic. The settings logic can provide additional features (e.g., on the display 230) for enabling a user to configure settings for the e-reader device 200. A user can interact with a displayed menu or settings user interface to adjust one or more settings for the e-reader device 200 or for an e-book 221. For example, a user can adjust one or more of a display brightness for the display 230, a device name, hardware settings, software version, text size, font options, subscription or account settings, network settings (e.g., Wi-Fi settings, Bluetooth settings), content downloading settings, etc.

In some examples, the processor 210 can execute sharing instructions 253 for implementing the sharing logic 114, such as described in an example of FIG. 1. The sharing logic 114 can be in communication with the e-book logic 112 and/or the settings logic for the e-reader device 200, and can enable a user to set up or configure a sharing environment with other devices. For example, user of the e-reader device 200 can access a displayed menu or a settings user interface (e.g., a network settings user interface 233) to establish a private sharing network for purposes of operating an e-book sharing session with one or more other devices using the sharing network.

In one implementation, the user can access the network settings user interface 233, and select an icon or feature corresponding to creating a private sharing network on the network settings user interface (e.g., by tapping on the touchscreen). In response to receiving the request, the processor 210 can execute the sharing instructions 253 for implementing the sharing logic 114 in order to provide one or more user interfaces for configuring the sharing network. The user can create and configure the sharing network by providing a variety of input, including input for specifying a name for the private sharing network (e.g., an ad-hoc network using Bluetooth protocol, IEEE 802.11 protocol, other wireless protocols, etc.), specifying a name for an e-book sharing session using the sharing network, designating a password for the sharing network and/or the sharing session, selecting an e-book 221 (or multiple e-books 221) for use during the sharing session, identifying other user(s) or device(s) that can join the sharing network and/or participate in the sharing session (e.g., invite users), and/or specifying settings or information particular to that sharing session. Information about the sharing network and the e-book sharing session can be stored in the memory 250 and can be used by the sharing logic 114 when the sharing network and/or sharing session is initiated by the user.

For example, the user of the e-reader device 200 (e.g., the host user) can provide input to create a sharing network and configure the settings for the sharing network and/or sharing session (e.g., share settings 241). The settings 241 for the e-book sharing session can specify how much control the host user and/or other users can have over the e-book sharing session. The amount of control that users can have during the e-book sharing session can be tailored by the host user depending on the purpose of the sharing session. As an example, for a book club environment, the settings for the e-book sharing session can be configured to enable both the host user and other users to have equal control (e.g., full control) over a synchronized page displayed on all the devices. In this case, all members that are participating in the sharing session can be enabled to perform e-book activities on their respective e-reader devices and have the other members' e-reader devices perform the same e-book activities in unison or in tandem. In this manner, a first user can change the page, leave group annotations or notes, highlight text, etc., on the first user's e-reader device, and cause a second user's e-reader device to perform a similar e-book activity, and vice versa.

In other examples, the host user can configure the settings 241 for the e-book sharing session so that the host user or another specific user can have more control (or different or less e-book activity control) than other users that are participating in the sharing session. For example, in a classroom or academic setting, the host user can be a teacher or professor that leads or guides the rest of the users (e.g., students) through use of an e-book. The host user can configure the settings 241 so that the host user can have control over the majority of the e-book activities while the other users have limited to no control. In this case, the host user's e-reader device can be configured to have more control during the e-book sharing session so that the host user can perform e-book operations on the e-book, such as page-turning or generating annotations, and the other users can simply follow along. In this manner, the host user (e.g., the teacher) can maintain full control over the flow and content of the sharing session, but all guests can have the benefit of the host user's annotations.

Depending on implementation, while the host user can configure the settings 241 for the sharing session specifying how much control the host user and/or other users can have over the sharing session, the other users can specify their own individual settings on their respective e-reader devices that supplement the settings for the sharing session. For example, the settings for the sharing session can enable all users participating in the sharing session to make group annotations on the e-book. Individual users, however, can specify in their own settings whether to enable or disable group annotations so that the annotations are either recorded or not recorded in their own e-books. In some examples, only certain settings can be individualized by users, such as group annotations or zoom operations, so that collaboration and synchronization can be generally maintained (e.g., no overriding of page-turning or page-skipping events).

Once the host user of the e-reader device 200 creates the private shared network for purposes of operating an e-book sharing session, the processor 210 can implement the sharing logic 114 to provide information about the shared network and the sharing session (e.g., session information 223) to other e-reader devices (not shown in FIG. 2). These other e-reader devices may be been specified by the host user to join the sharing network via the share settings 241 (e.g., by specifying user identifiers or accounts, or by specifying device names). In other examples, the sharing logic 114 can cause the e-reader device 200 to perform a discovery process to identify devices that are in proximity to the e-reader device 200. The session information 223 can be provided by the network interface 220 to the e-reader devices. The other users can then join the sharing network by inputting the appropriate password on their respective e-reader devices. In this manner, the e-reader device 200 can establish a wireless connection with the other e-reader devices.

Although not shown in FIG. 2, the other e-reader devices can include the same components of the e-reader device 200. A guest e-reader device, for example, can include a network interface to receive the session information 223 from the e-reader device 200 (e.g., operated by the host) and can implement the sharing logic to use the session information 223 for purposes of joining the sharing network.

After the wireless connection is established with at least one other e-reader device, in one example, the host user can initiate the e-book sharing session (e.g., operate the e-reader device 200 in a sharing mode). The host user can initiate the e-book sharing session by (i) selecting or opening the e-book 221 for which the e-book sharing session is specified, or (ii) selecting a icon or selectable feature (e.g., “start session” feature) that causes the specified e-book to be opened or launched, thereby causing the same e-book 221 to be opened on the at least one other e-reader device. Each of the e-reader devices in the sharing network can display the same page 231 of the e-book 221 on the display. Still further, in another example, the e-book sharing session can be initiated in response to at least one other e-reader device joining the sharing network.

During a duration of the e-book sharing session, the sharing logic 114 can communicate with the e-book logic 112 on each of the e-reader device 200 and the other e-reader devices (e.g., guest e-reader devices that joined the sharing network). In one example, during the e-book sharing session, when the host user provides an input on the e-reader device 200 to perform an e-book activity (e.g., e-book interaction 243) on a displayed page, such as an input to change the displayed page to the next page, the e-book logic 112 can perform the corresponding e-book activity based on the user input. Depending on implementation, the sharing logic 114 can concurrently receive information about the corresponding e-book activity from the e-book logic 112 or independently monitor the user inputs to determine the corresponding e-book activity to be performed on other devices based on the user input. The sharing logic 114 can provide a control signal(s) or a control message(s) 225 corresponding to the e-book activity to be outputted to the other e-reader devices using the wireless connection (provided that the sharing logic 115 determines from accessing the session information 223 that the user is allowed to or is enabled control to perform the e-book activity).

Each of the other e-reader devices can receive the control signal(s) 225 from the e-reader device 200 and each respective sharing logic 114 can determine what e-book activity is to be performed on the e-book. The sharing logic 114 can cause the corresponding e-book activity (that is identical to the e-book activity performed on the e-reader device 200) to be performed on the displayed page of the other e-reader device. In this manner, page operations (and other e-reader activities) on an e-book can be performed on multiple e-reader devices concurrently or in unison (or substantially in unison).

Similarly, the e-reader device 200 can receive a control signal(s) or a control message(s) 227 that is provided by another e-reader device. For example, the host user may have configured the settings for the sharing session to enable other users to generate group annotations. If a user of a guest e-reader device provided an input to generate an annotation, the sharing logic 114 implemented on the guest e-reader device can output a control signal(s) corresponding to that e-book activity. The e-reader device 200 can receive the control signal(s) 227 corresponding to the generated annotation and the sharing logic 114 of the e-reader device 200 can cause the e-reader device 200 to perform the e-book activity (e.g., generate the same annotation on its displayed page).

As discussed, control signals from one e-reader device are provided to other e-reader devices in accordance with the settings specified for the sharing session. The session information 223 can include the settings that indicate which user(s) have control or are permitted to perform certain e-book activities over a synchronized page displayed on the e-reader devices. If a specific e-reader device(s) or a user operating a specific e-reader device has no control over synchronized e-book activities (such as a student in a classroom setting), for example, inputs provided by that user on the e-book causes the e-book activity to be performed only on that respective e-reader device. In such an example, no control signal(s) corresponding to that e-book activity are provided to other e-reader devices.

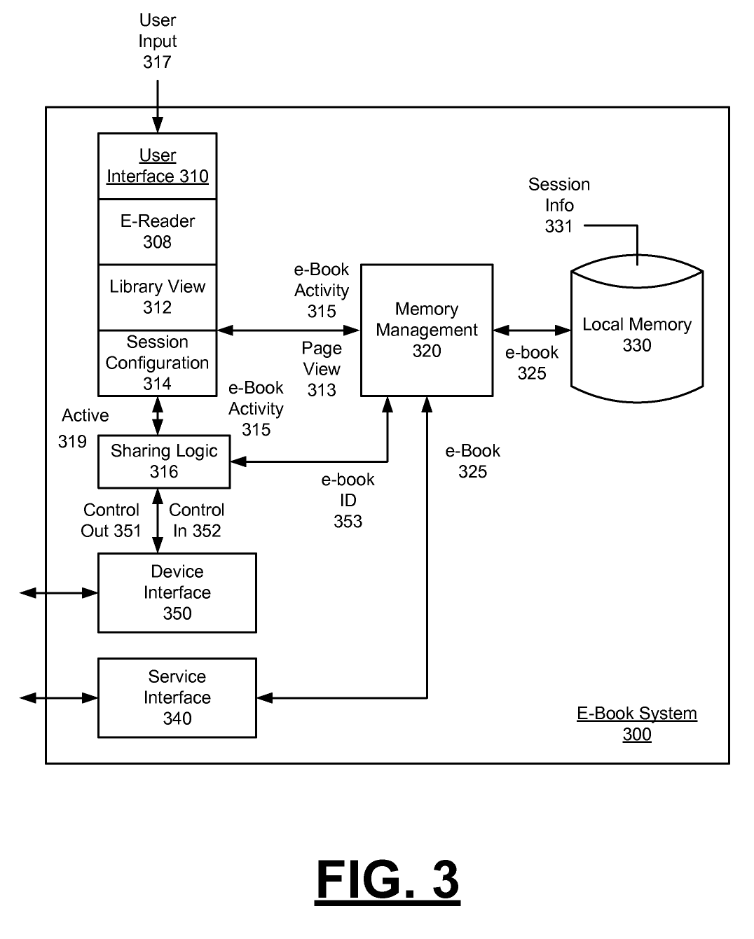

FIG. 3 illustrates an e-book device system for performing synchronized e-book activities with another computing device, according to an embodiment. With reference to FIG. 3, an e-book system 300 implements programmatic components for communicating with an e-book service (such as network service 120, shown in FIG. 1) and one or more other e-book reader devices, as well as for enabling functionality for viewing and accessing e-books utilized by an account associated with the e-reader device 110a, 110b (see FIG. 1 or FIG. 2). In some embodiments, system 300 can be implemented as an application that runs on an e-reader device, such as shown with examples of FIG. 1 or FIG. 2.

According to an example of FIG. 3, system 300 includes a user interface 310, sharing logic module 316, a memory management module 320, a local memory 330, a service interface 340, and a device interface 350. Some or all of the programmatic components shown with the computing system 300 can be provided in part as operating system-level components. Alternatively, the programmatic components shown with system 300 can be provided as part of an application that runs on, for example, the e-reader device 110a or 110b of FIG. 1 or the e-reader device 200 of FIG. 2. For example, the user can download an application onto the e-reader device 110a to obtain functionality such as described with an example of FIG. 3. Alternatively, the application can be embedded or otherwise pre-installed with other programmatic elements for providing functionality such as described with system 300. Although examples described herein refer to system 300 being implemented on an e-reader device 110a of FIG. 1 or an e-reader device 200 of FIG. 2, in other examples, at least one or more of the programmatic components can be implemented on other devices, such as on another computing device that is in communication with the e-reader device (e.g., a paired or peer-to-peer device), or on one or more computing devices associated with the network service 120.

The service interface 340 includes application logic which enables the e-reader device 110a to use, for example, a wireless network connection (e.g., Internet connection), to connect to the network service 120 (see FIG. 1). In connecting with the network service 120, the service interface 340 can transmit data that enables the network service 120 to identify the e-reader device 110a on which system 300 is implemented (e.g., using a device identifier), so that the network service 120 can determine the account that is associated with the particular e-reader device 110a. The service interface 340 can be used to retrieve and/or download one or more content items (e.g., e-books 325) from the network service 120 and store the one or more content items in the local memory 330.

For example, in identifying the e-reader device 100a of system 300 to the network service 120, the network service 120 may be able to procure payment information (e.g., stored credit card information) that can be used to charge the user's account when the user purchases a new e-book 325 from the network service 120. Each e-book 325 can correspond to a literary work having a pagination format and a predefined structure. Optionally, some e-books may have chapter designations, as well as content that corresponds to graphics or images (e.g., in the case of magazines, children's books, comic books, etc.). Individual e-books 325 can also include metadata, such as imagery provided as a cover for the e-book 325 when the e-book 325 is marketed (e.g., similar to the manner in which a conventional hardbound book would be marketed in a retail store) or other information, such as publication date, date the e-book was made available, author information, language, etc. In one implementation, the network service 120 can retrieve or otherwise identify the imagery and other metadata of individual e-books from publisher sources.

In addition, in identifying the e-reader device 110a of system 300, the network service 120 can also identify what e-books 325 belong to the account of that device (e.g., have been purchased or downloaded). The e-books 325 that are transmitted to the e-reader device 110a of system 300 include those that are purchased from the e-reader device 110a or those that the user requested to download. In variations, e-books 325 can automatically be downloaded to the e-reader device 110a in response to occurrence of certain conditions. For example, the user can purchase an e-book on another device, and then subsequently connect the e-reader device 110a to the network service 120 to automatically receive their previously purchased e-book. Alternatively, as another example, the network service 120 can be configured to push e-books 325 to the e-reader device 110a of system 300, based on, for example, user account settings, subscription plans and rules, and/or various other business logic considerations.

Additionally, the service interface 340 can include processes for automatically receiving updates from the network service 120. The update(s) can include programmatic updates, including updates to existing programmatic components on the e-reader device 110a, as well as updates to lists, e-books 325 that the user may have purchased on another device of the same account, recommendations from the network service 120 as to what a given user may want to purchase or view, and/or various other data that can be either generally provided to the user of the network service 120 or specifically provided for to the particular account or user.

According to some embodiments, the local memory 330 stores each e-book 325 as a record that includes metadata and content (e.g., page content). The memory management module 320 can retrieve portions of individual e-books 325 for purpose of rendering e-books via the user interface 310.

Among other functionality, the user interface 310 can include an e-reader component 308, a library view component 312, and a session configuration component 314. The e-reader component 308 operates to display content corresponding to, for example, a portion of content of a content item (e.g., a paginated content or page from an e-book 325). The e-reader component 308 can also detect and respond to user inputs 317 made to the e-book 325. The e-reader component 308 can allow user interaction with the displayed page 313 by enabling the user to view other portions of content via user input 317 or by providing prompts or features for enabling the user to enter inputs. In some example, a user input 317 can correspond to an e-book activity 315 that is to be performed on a displayed page 313 of the e-book 325. Examples of an e-book activity 315 can correspond to a page-turning/jumping operation corresponding to transitioning from one page to the next, or from one page by cluster to another, or from one chapter to another, highlighting text on the displayed page 313, generating an annotation on the displayed page 313, displaying a definition of a text item, or zooming in or zooming out of the displayed page 313. The memory management module 320 can receive the user inputs 317 and update the displayed page 313 for the e-reader component 308 and/or perform the corresponding e-book activity 315 based on the user inputs 317.

The library view component 312 can display graphic representations and other information of individual e-books 325 in the user's collection. For example, the library view component 312 can use the metadata associated with the records of the e-books 312 in the user's account to display lists, folders, or other virtual structures that include graphic representations and/or other identifiers of e-books 325 in the user's collection. The user's collection can include e-books 325 that the user has on the particular device (e.g., locally stored e-books 325), as well as e-books 325 that may not be locally stored, but are associated with the user account (e.g., read on another device, archived, etc.).

In one implementation, the local memory 330 can include records for each e-book 325 in the user's account, and each record 326 can include its metadata. The user may have the content portion of select e-books 325 archived, so as not to reside in the local memory 330, but be provided by the network service 120 as requested or needed. By way of example, the library view component 312 can display the e-books 325 of a user's collection using a virtual book shelf or bookcase feature in which the e-books 325 are provided. In such an implementation, the e-books 325 are displayed as icons that include imagery, title information, etc. In a variation, the library view component 312 can display representations of e-books 325 in the user's collection as icons, or as icons with associated text. Still further, folders can be used to provide a panel view of the graphic representations (e.g., icons and/or text) of the e-books 325 in the user's collection.

The session configuration component 314 can operate to display user interfaces for enabling a user of system 300 to create and configure a private sharing network with other e-reader devices. A user interface for creating a private sharing network can be displayed, for example, in response to a user input 317 corresponding to a selection of a feature in a menu or settings user interface. The user can interact with the user interfaces provided by the session configuration component 314 to create a private sharing network, specify the name of the sharing network and/or the e-book sharing session, configure the settings for the sharing session (including identifying the e-book for the sharing session), provide a password for the sharing network and/or the sharing session, and/or identify which users or e-reader devices are invited to join the sharing network and participate in the sharing session. Based on the user inputs 317 provided with respect to the user interfaces, the memory management module 320 can store the sharing network information and the sharing session information in the local memory 330 as session information 331. In addition, the user can provide an input 317 to the session configuration component 314 to initiate the sharing logic module 316 (e.g., provide an active signal or message 319) and create the sharing network. Initiating the sharing logic module 316 can cause system 300 to operate in a sharing mode as compared to a normal operating or reading mode.

When the user creates the sharing network, the sharing logic module 316 can communicate the session information 331 to other devices via the device interface 350 (e.g., to e-reader devices that are specified in the settings or to e-reader devices that are in proximity to the e-reader device implementing system 300). The sharing logic module 316 that is implemented on the other e-reader devices can use the session information 331 to join the sharing network created by the user of system 300. The device interface 350 can include application logic which enables system 300 to use a wireless network connection to connect to the other devices (e.g., via Bluetooth protocol, an IEEE 802.11 protocol, or other wireless protocol). The device interface 350 enables system 300 to communicate with the other devices for purposes of synchronizing e-book operations.

In some examples, the sharing logic module 316 can receive a confirmation message from those devices that have joined the sharing network. The sharing logic module 316 can provide information about which devices have connected with system 300 to the user interface 310, thereby displaying to the user of system 300 an indication of those users who have or who have not joined the sharing network.

Depending on implementation, the user of system 300 can provide an input to initiate an e-book sharing session using the sharing network. For example, the e-book sharing session can be initiated in response to the user opening or launching the specified e-book 325 from the user's collection displayed by the library view component 312. In another example, the user can select a start icon or feature, which causes the memory management component 320 to automatically retrieve the specified e-book 325 (e.g., specified in the session information 331) from the local memory 330 and cause the e-reader component 308 to display a portion of content (e.g., a page 313) of the e-book. As another example, the e-book sharing session can be automatically initiated in response to the user creating the sharing network and the e-book 325 can be automatically retrieved and displayed.

In some instances, a guest e-reader device that joins the sharing network may not have the specified e-book 325 or the same version of the e-book 325 stored locally or may not have access to the e-book 325 (e.g., a user of the guest e-reader device may not have yet purchased the e-book 325). In such cases, when the guest e-reader device joins the sharing network, system 300 running on that e-reader device may automatically prompt the user to purchase the e-book 325 or may automatically connect to the resource store 122 (see FIG. 1) to enable the user to purchase the e-book 325.

For example, the sharing logic module 316 of system 300 of the guest e-reader device can receive the session information 331 from the host e-reader device via the device interface 350. The session information 331 can include information about the sharing network as well as information about the e-book 325 (e.g., e-book ID 353) for the e-book sharing session (as well as the version information, in one example). The sharing logic module 316 uses the session information 331 to join the sharing network (e.g., in response to the guest user input to join the sharing network, such as input to corresponding to the appropriate password for the sharing network) and provides the e-book ID 353 to the memory management component 320. The memory management component 320 can use the e-book ID 353 to determine whether the guest user of the guest e-reader device has the corresponding e-book 325 stored in the local memory 330 and/or communicate via the service interface 340 to determine whether the guest user has an account in which the corresponding e-book 325 is already accessible (and can be downloaded, e.g., without purchasing again).

If the memory management component 320 determines that the e-book 325 is stored in the local memory 330, the memory management component 320 can cause the e-reader component 308 to display the e-book 325 (e.g., a page 313 of the e-book 325) when the e-book sharing session is initiated by the host e-reader device. For example, the sharing logic module 316 can receive a control signal(s) or a control message(s) from the host e-reader device indicating that the sharing session has started. On the other hand, if the memory management component 320 determines that the guest user does not have the e-book 325 in the local memory 330 or in an online server-based e-book library collection associated with the guest user, the memory management component 320 can cause the user interface 310 to display a prompt on the guest e-reader device that the e-book 325 needs to be purchased and/or downloaded. The guest user can interact with the prompt to open an interface corresponding to the resource store 122 and download the e-book 325. In another example, the memory management component 320 can open or launch the interface corresponding to the resource store 122 in response to determining that the e-book 325 needs to be downloaded. The memory management component 320 can communicate with the resource store 122 via the service interface 340 and download the e-book 325 in response to user input.

Once the e-reader devices (including the host e-reader device) have joined the sharing network, system 300 operating on each of the e-reader devices can display the same content (e.g., page 313) of the e-book 325 on the display. During a duration of the e-book sharing session, the e-book 325 that is displayed on the individual e-reader devices can be synchronized so that e-book activities pertaining to the e-book 325 can be performed in unison (or substantially in unison) on the individual e-reader devices. Based on the settings for the e-book sharing session specified by a host user, users of the e-reader devices can have different control over the e-book activities that are to be synchronized between the devices.

The sharing logic module 316 of system 300 of each e-reader device can provide control signals or messages 351 to be outputted to other e-reader devices and/or receive control signals or messages 352 from the other e-reader devices. The control signals 351, 352 can correspond to e-book activities that are performed on an e-book 325 on e-reader device. For example, an e-reader device can be enabled (permitted control over) to perform a page-turning activity and cause other e-reader devices to perform the same page-turning activity (e.g., selectively enabled to perform synchronized page-turning or enabled to have full control over the sharing session). When a user of that e-reader device provides an input 317 to perform the page-turning activity (e.g., an e-book activity 315), the e-reader component 308 can detect and respond to the user input 317 made to a page 313 of the e-book 325. The memory management module 320 can receive the user input 317 and cause the e-reader component 308 to perform the activity (e.g., display a new page 313). Concurrently, the sharing logic module 316 can receive indication of the page-turning activity (e.g., the specified e-book activity 315) from the user interface 310 and/or the memory management 320 and generate a control signal(s) or message(s) 351 corresponding to that e-book activity 315 to be outputted to other e-reader devices. In some examples, the sharing logic module 316 can transform or translate the user input 317 corresponding to the e-book activity 315 to the control signal(s) or message(s) 351. The other sharing logic modules 316 operating on system 300 on the other e-reader devices can receive the control signal(s) or messages(s) (e.g., as control in 352) and determine the corresponding e-book activity 315 to be performed on the respective e-reader devices.

In some implementations, when a user of an e-reader device or the e-reader device is not enabled to have synchronized control over one or more e-book activities, inputs made by the user corresponding to those e-book activities does not cause the sharing logic module 316 to output control signal(s) for those e-book activities to other e-reader devices. For example, a student user may not have synchronized control during an e-book sharing session, while the host user (e.g., a teacher) may have full synchronized control. When the user provides inputs to highlight text or generate annotations on the e-book on his or her e-reader device, the e-reader device can perform the corresponding e-book activity on the displayed page of the e-book, but the sharing logic module 316 does not provide control signal(s) 351 to be provided to the other e-reader devices that are participating in the e-book sharing session. In this manner, system 300 can enable e-book activities to be synchronized between the e-reader devices during a sharing session, in accordance with the settings for the e-book sharing session (e.g., control settings).

In one example, once the sharing session is to be ended, the host user of the host e-reader device can provide input via the user interface 310 to terminate the e-book sharing session and/or the sharing network. In another example, the sharing session can be ended, but the sharing network can still be active so that another sharing session can be initiated using the sharing network with other e-reader devices. For example, in a classroom setting, a class may be dismissed so that the sharing session is ended for that class, but a subsequent class may be starting shortly and another sharing session can be initiated using the sharing network without terminating the sharing network. When a specified session is terminated, the wireless connection(s) between the host e-reader device and the other e-reader device(s) are also terminated. In another implementation, the sharing session and/or the sharing network can be schedule to terminate at a designated or preprogrammed time (e.g., as specified in the session information 331).

In this manner, system 300, which operates on individual e-reader devices, enables e-book activities on displayed pages of e-books to be synchronized for purposes of promoting a group reading experience. Such a system enables users to collaborate together during study groups, book clubs, or classroom settings using e-reader devices.

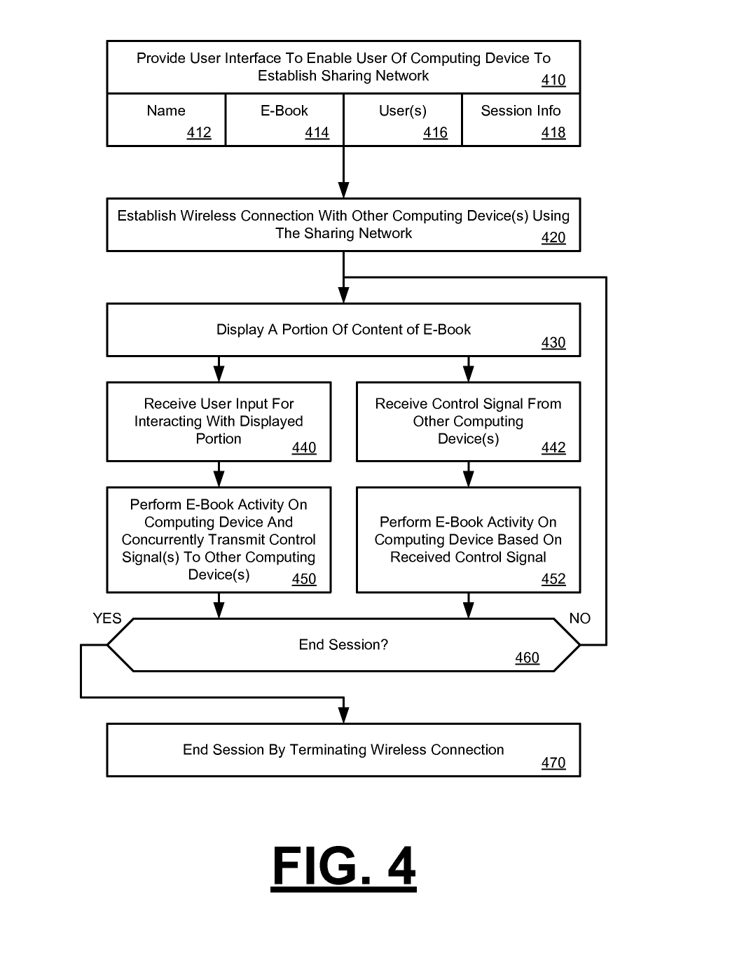

FIG. 4 illustrates a computer-implemented method for performing synchronized e-book activities with another computing device, according to at least some embodiments. A method such as described by an example of FIG. 4 may be implemented using components such as described with an example of FIG. 1, FIG. 2, and/or FIG. 3. Accordingly, reference may be made to elements of other figures for purpose of illustrating an example of a suitable component for performing a step or sub stepping described.

With reference to FIG. 4, a computing device (e.g., e-reader device 110a of FIG. 1) can provide a user interface(s), on a display of the computing device, to enable the user of the computing device to create or establish a private sharing network (410). In one example, such a user can correspond to a host user operating a host e-reader device. The user can interact with the displayed user interface(s) to create the sharing network for purposes of establishing a sharing session between the host e-reader device and other e-reader device(s) (e.g., guest e-reader devices, such as e-reader device 110b of FIG. 1).

The user can interact with the displayed user interface(s) to input a variety of information about the sharing network and/or the sharing session to be established using the sharing network. According to examples, the user can provide a name for the sharing network and/or the sharing session (412), identify an e-book for the sharing session (414), identify or invite users or e-reader devices of those users (416), and/or other session information (418), such as a password for the sharing network and/or the sharing session, and synchronized control settings (e.g., settings that determine how much control over the synchronized reading experience the host user and/or the guest users can have).

The host e-reader device can establish a wireless connection with the guest e-reader device(s) using the sharing network when the guest e-reader device(s) join the sharing network (420). In some examples, the guest e-reader devices can also establish a wireless connection with other guest e-reader devices. For example, the host e-reader device can implement a sharing logic module 316 (e.g., as part of system 300 of FIG. 3) to provide information about the sharing network and/or the sharing session (e.g., referred to as session information 331) to the guest e-reader devices. The guest e-reader devices can also individually implement a sharing logic module 316 to receive the session information 331, and to enable the guest e-reader device to join the sharing network and establish a wireless connection with the host e-reader device and/or other e-reader device(s).

When the sharing session is initiated, a portion of content (e.g., a page) of the e-book is displayed on the host e-reader device (430). Similarly, the same page of the e-book is also displayed on the guest e-reader devices that are participating in the sharing session. In one example, the host user of the host e-reader device can initially open the e-book to a particular page, thereby causing the sharing logic module 316 to provide a control signal or message to the guest e-reader devices of what page of the e-book to initially display. In this manner, when the sharing session is initiated, all participants of the sharing session can be automatically synchronized to the same page.

During the sharing session, users of the host e-reader device and/or the guest e-reader devices can provide user input for interacting with the displayed page (e.g., to perform e-book activities) (440). Based on the session information 331, one or more of the host e-reader device and the guest e-reader devices may not be allowed to perform synchronized e-book activities on other devices. In such case, a user input for interacting with the displayed page on an e-reader device can cause the e-book activity corresponding to the user input to only be performed locally on that e-reader device.

On the other hand, the session information 331 can enable one or more of the host e-reader device and the guest e-reader devices to perform one or more synchronized e-book activities on other devices. For example, in response to the host e-reader device receiving user input for interacting with the displayed page, the host e-reader device can perform the corresponding e-book activity with respect to the displayed page (e.g., locally) and concurrently transmit, to the other e-reader device(s) in the sharing session, a control signal(s) or message(s) that causes the other e-reader device(s) to perform an identical corresponding e-book activity on the page displayed on the other e-reader device(s) (450). In this manner, the e-reader devices can perform synchronized e-book activities on the e-book during the sharing session.

Similarly, during the sharing session, the host e-reader device can also receive a control signal(s) or message(s) from the other e-reader device(s) corresponding to e-book activities performed by the user on the other e-reader device(s), provided that those other e-reader device(s) are permitted or allowed to have synchronized control (442). For example, the sharing logic module 316 of the host e-reader device can use the received control signal(s) or message(s) from the other e-reader device(s) to determine the e-book activity and perform the e-book activity on the host e-reader device (452). In this manner, during the sharing session, when a page-turning activity or a highlighting text activity, for example, is performed on one e-reader device, the same page-turning activity or highlighting text activity can be performed on the other participating e-reader devices.

The e-reader device can continue to receive user input and/or receive control signal(s) from other devices (in accordance with the session information 331), and respectively, respond by performing the e-book activity and/or transmitting control signal(s) to other devices until the sharing session and/or the sharing network is ended. When the sharing session and/or the sharing network is terminated (460), the wireless connections between the host e-reader device and the other e-reader devices can also be terminated (470). The wireless connections between the other e-reader devices themselves can also be terminated.

As an addition or an alternative, the guest e-reader devices do not establish a wireless connection with other guest e-reader devices, but just with the host e-reader device. In such an example, the host e-reader device can be a centralized host device so that e-book activities that are performed on a guest e-reader device is first provided to the host e-reader device, and the host e-reader device then provides the corresponding control signal(s) or message(s) to the other guest e-reader devices for purposes of synchronizing e-book activities within the sharing session.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is being claimed is:

1. A method of operating devices during a specified session, the method being performed by one or more processors of a computing device and comprising:
establishing a wireless connection with at least one other computing device using a sharing network;
displaying, on a display of the computing device, a portion of content of an e-book;
receiving user input for interacting with the displayed portion; and
in response to receiving the user input, (i) performing an e-book activity with respect to the displayed portion based on the user input, and (ii) concurrently transmitting, to the at least one other computing device using the wireless connection, a control signal that causes the at least one other computing device to perform an identical corresponding e-book activity on a corresponding portion of content displayed on the at least one other computing device.

2. The method of claim 1, wherein the e-book is stored in each of a memory of the computing device and a memory of the at least one other computing device.

3. The method of claim 1, wherein the wireless connection is established using a Bluetooth protocol or an IEEE 802.11 protocol, and wherein the sharing network is an ad-hoc network.

4. The method of claim 1, wherein performing the e-book activity includes performing a page-turning operation in order to display another portion of content of the e-book.

5. The method of claim 1, wherein performing the action includes (i) highlighting text on the displayed portion, or (ii) generating an annotation associated with the displayed portion.

6. The method of claim 1, wherein performing the action includes (i) displaying a definition of selected text on the displayed portion, or (ii) zooming in or zooming out the displayed portion.

7. The method of claim 1, further comprising:
providing, on the display of the computing device, a user interface to enable a user to establish the sharing network, the user interface including a plurality of prompts requesting the user to (i) provide a name for the sharing network, (ii) select the e-book, and (iii) select one or more other users to connect to the computing device.

8. The method of claim 7, further comprising:
enabling the user of the computing device to configure what actions the one or more other users can perform on the corresponding portion of content displayed on the at least one other computing device during the specified session.

9. The method of claim 1, further comprising:
receiving, from one of the at least one other computing device, a second control signal; and
in response to receiving the second control signal, performing a second e-book activity with respect to the displayed portion based on the second control signal.

10. The method of claim 1, further comprising:
enabling a user of the computing device to end the specified session, wherein ending the specified session causes the wireless connection with the at least one other computing device to be terminated.

11. A non-transitory computer-readable medium storing instructions that, when executed by one or more processors of a computing device, cause the computing device to perform operations comprising:
establishing a wireless connection with at least one other computing device using a sharing network;
displaying, on a display of the computing device, a portion of content of an e-book;
receiving user input for interacting with the displayed portion; and
in response to receiving the user input, (i) performing an e-book activity with respect to the displayed portion based on the user input, and (ii) concurrently transmitting, to the at least one other computing device using the wireless connection, a control signal that causes the at least one other computing device to perform an identical corresponding e-book activity on a corresponding portion of content displayed on the at least one other computing device.

12. The non-transitory computer-readable medium of claim 11, wherein the e-book is stored in each of a memory of the computing device and a memory of the at least one other computing device.

13. The non-transitory computer-readable medium of claim 11, wherein the wireless connection is established using a Bluetooth protocol or an IEEE 802.11 protocol, and wherein the sharing network is an ad-hoc network.

14. The non-transitory computer-readable medium of claim 11, wherein the instructions cause the computing device to perform the e-book activity by performing a page-turning operation in order to display another portion of content of the e-book.

15. The non-transitory computer-readable medium of claim 11, wherein the instructions cause the computing device to perform the e-book activity by (i) highlighting text on the displayed portion, (ii) generating an annotation associated with the displayed portion, (ii) displaying a definition of selected text on the displayed portion, or (iv) zooming in or zooming out the displayed portion.

16. The non-transitory computer-readable medium of claim 11, wherein the instructions cause the computing device to further perform operations comprising:
providing, on the display of the computing device, a user interface to enable a user to establish the sharing network, the user interface including a plurality of prompts requesting the user to (i) provide a name for the sharing wireless network, (ii) select the e-book, and (iii) select one or more other users to connect to the computing device.

17. The non-transitory computer-readable medium of claim 16, wherein the instructions cause the computing device to further perform operations comprising:
enabling the user of the computing device to configure what actions the one or more other users can perform on the corresponding portion of content displayed on the at least one other computing device during a specified session.

18. The non-transitory computer-readable medium of claim 11, wherein the instructions cause the computing device to further perform operations comprising:
receiving, from one of the at least one other computing device, a second control signal; and
in response to receiving the second control signal, performing a second e-book activity with respect to the displayed portion based on the second control signal.

19. The non-transitory computer-readable medium of claim 11, wherein the instructions cause the computing device to further perform operations comprising:
enabling a user of the computing device to end the specified session, wherein ending the specified session causes the wireless connection with the at least one other computing device to be terminated.

20. A computing device comprising:
one or more memory resources that stores instructions and one or more e-books;
a display;
an input mechanism;
a network interface; and
one or more processors, coupled to the one or more memory resources, the display, the input mechanism, and the network interface, that executes the instructions, the instructions causing the computing device to perform operations comprising:
establishing a wireless connection with at least one other computing device using a sharing network;
displaying, on a display of the computing device, a portion of content of an e-book;
receiving user input for interacting with the displayed portion; and
in response to receiving the user input, (i) performing an e-book activity with respect to the displayed portion based on the user input, and (ii) concurrently transmitting, to the at least one other computing device using the wireless connection, a control signal that causes the at least one other computing device to perform an identical corresponding e-book activity on a corresponding portion of content displayed on the at least one other computing device.
